(19) United States
(12) Patent Application Publication
(10) Pub. No.: US 2005/0091101 A1
(43) Pub. Date: Apr. 28, 2005

(54) Systems and methods for user-tailored presentation of privacy policy data

(76) Inventors: Jeremiah Seth Epling, Redmond, WA (US); Tony Schreiner, Redmond, WA (US); Jingyang Xu, Redmond, WA (US); Andrew G. Bybee, Duvall, WA (US); Angela Butcher, Duvall, WA (US)

Correspondence Address: LEE & HAYES PLLC, 421 W RIVERSIDE AVENUE SUITE 500, SPOKANE, WA, 99201, US

(21) Appl. No.: 10/693,333

(22) Filed: Oct. 24, 2003

(51) Int. Cl. G06F 17/60

(52) U.S. Cl. 705/10; 705/26

(57) ABSTRACT

Systems and methods are described for determining conflicts between user concerns and a Web site privacy policy. A set of user concerns is compared to the privacy policy to identify any potential problems that might exist for the particular user. If any conflicts are found between the privacy policy and the user concerns, the privacy policy is transformed to provide a user view that emphasizes the concerns that are conflicted. As a result, the user can focus on only the portion(s) of the privacy policy that are of interest to the user.

### TECHNICAL FIELD

The systems and methods described herein relate generally to computer-based privacy policies and specifically to evaluating computer-based privacy policies for presentation according to user preferences.

### BACKGROUND

An intense concern for security of private personal data that is stored in computer-readable media and/or transmitted across networks has forced virtually every entity handling personal data on the Internet to create and enforce strict privacy policies for protecting dissemination of that data.

In the development of the Internet, web site designers found it necessary to use cookies to provide smoother content rendering and provide greater functionality to web services. Over time, users became more and more concerned over privacy that was given up when web sites were allowed to store cookies on their systems. To address these concerns, some web browsers implemented user-settable privacy levels. Users could now limit web sites that were allowed to store cookies on the users' systems.

Lately, the concern for privacy has grown far beyond the concern over cookies to providing personal information that is stored in computer-readable media or transmitted over networks, including the Internet. As business have increased online services and the number of online-based business has grown, it is common for people to transmit personal data over the Internet. For instance, if a user is purchasing a book from an online bookstore, the user may transmit his name, address, phone number, credit card number, etc. to the merchant. There are also instances where a user may transmit a social security number or health-related information over the Internet.

As the public became more and more aware of how businesses could exploit this data, users began to be concerned about what an entity would do with their information once it was turned over by the user.

In response to this concern, the World Wide Web Consortium (W3) was created. The W3 developed the Platform for Privacy Preferences Project (P3P) that is now emerging as an industry standard that for providing a way for users to gain more control over the use of personal information on Web sites they visit.

Basically, P3P is a standardized file that contains all major aspects of a Web site's privacy policies. The privacy policies are stored in an XML (eXtensible Markup Language) file and present a snapshot of how the Web site handles personal information about its users. Some browsers that are P3P-enabled can access the XML file and transform the policies into a human-readable format for presentation to a user.

A problem with this is that the Web site policies are presented to the user in a site-centric format. In other words, the user sees the policies in the way in which the Web site developer wants the user to see them. Often, a user will not sift through the mountain of information that is presented to find the policies with which the user is particularly concerned. Many sites simply dump the legal information that is required to be provided under certain circumstances. Furthermore, many policies are presented in a legalese that users may not understand or do not want to take the time to comprehend.

### SUMMARY

Systems and methods are described for evaluating Web site privacy policies and transforming the policy data into a user-centric view for presentation to a user according to a set of concerns designated by the user. When a user accesses a P3P-enabled Web site, a trust engine on the user's computer accesses a policy file on the Web site and compares policies contained therein to concerns designated by the user.

It is noted that, although the discussion herein primarily deals with the networks such as the Internet, the principles set forth herein also apply to any privacy policy that deals with personal information that is stored on a machine-readable medium.

The user is informed of any conflict that may be found between the policies and the concerns via a user-friendly interface that presents the privacy policy in a manner that addresses the user's concerns according to a priority designated by the user. Conflicts found with concerns identified by the user as important to the user are presented initially and the remainder of the privacy policy is presented afterward. In addition, the language of the policy may be supplemented or revised to a more easily comprehendible language than that initially included with the policy file.

### BRIEF DESCRIPTION OF THE DRAWINGS

A more complete understanding of exemplary methods and arrangements of the present invention may be had by reference to the following detailed description when taken in conjunction with the accompanying drawings wherein:

FIG. 1 is a block diagram of a system in accordance with the systems and methods described herein.

FIG. 2 is a flow diagram depicting a methodological implementation of the systems and methods described herein.

FIG. 3 is a flow diagram depicting a methodological implementation of comparing policy statements to user concerns and arranging data for presentation via a user interface.

FIG. 4 is an exemplary computing environment in accordance with the systems and methods described herein.

### DETAILED DESCRIPTION

Systems and methods are described herein for evaluating Web site policies against user concerns, transforming the policies according to the user concerns, and presenting the transformed policy data to the user in a way that makes it easier for the user to understand the policy as related to concerns the user has expressed about the user's personal data.

Personal data includes, but is not limited to, personal private data (such as social security number, telephone number, etc.), financial data (such as credit card data, bank data, insurance data, etc.), health data (doctor's information, personal health condition data, etc.), and the like. Any personal data that a user would typically like to protect from misuse and abuse qualifies as personal data as used herein.

The systems and methods described herein are depicting in one or more implementations. However, it is noted that the invention is not limited to a particularly described implementation. The implementations explicitly described herein are merely examples of how the present invention may be implemented.

One or more implementations described herein are described in the context of software modules. It is noted, however, that the functionality required to implement the elements described herein may be implemented in software modules, hardware modules, or a combination thereof.

Specific examples and discussions in this document refer to privacy specifications outlined in the Platform for Privacy Preferences Project (P3P) as promulgated by the World Wide Web Consortium (W3C). Any specific information concerning the specification that is not included in this document may be found on the Internet at one or more sites sponsored by the W3C organization.

Exemplary Network Environment/Architecture

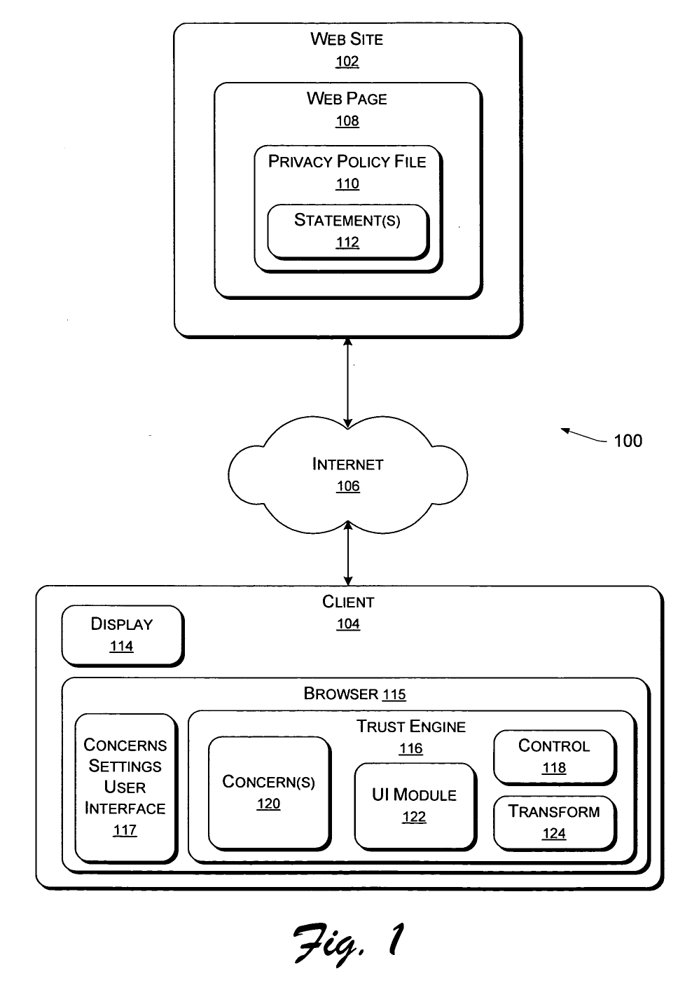

FIG. 1 is a block diagram of an exemplary system 100 showing a network environment in accordance with the description herein. System 100 includes a Web site 102 and a client 104 that communicate via the Internet 106. Although only one web site and one client are shown communicating over the Internet, it is noted that there may be several Web sites and/or clients and they may communicate over any type of network other than the Internet, such as a Local Area Network (LAN), a Wide Access Network (WAN), or the like. Also, although not specifically shown, the Web site 102 is understood to reside on a server computer (not shown). Such server computer (not shown) may be any computing device capable of performing server-like functions with regard to the functionality described in this document. It is not required that such a server computer (not shown) actually be a dedicated Internet server.

The Web site 102 includes at least one Web page 108 and a privacy policy file 110 having one or more policy statements 112. Although the privacy policy file 10 is shown as being a part of the Web page 108, it is noted that the Web site 102 may include the privacy policy file 110. In other words, the Web site 102 may include one privacy policy file that applies to all Web pages contained within the Web site 102, or each Web page contained in the Web site 102 may have its own privacy policy file associated with it.

The client 104 is a typical computer, such as a personal computer, and includes a display 114 and a browser 115 that includes a trust engine 116 and a concerns settings user interface (UI) 117. The trust engine 116 may be a software module stored in memory (not shown) of the client 104 or may be a separate component that includes hardware and/or software. As described herein, the trust engine is a part of a browser that is stored in memory (not shown).

The trust engine 116 includes a control module 118, one or more concerns 120, a user interface (UI) module 122 and a transformation module 124. The control module 118 carries out the basic functionality of the features described herein that are not attributed to any other element. Furthermore, the control module 118 carries out other trust engine functions that are not related to the features described herein.

The concerns 120 are a list of one or more privacy concerns identified by the user. The user sets up the concerns 120 via the concerns settings UI 117 in the browser 115. The concerns settings UI 117 may include a selectable list of possible concerns that the user may have with a Web site. For example, a user might be concerned that personal information such as the user's address and telephone number may be distributed by the site to marketers who will use the personal data to market products to the user. Another example of a concern is that a user may be concerned with any Web site that stores the user's credit card data on a Web site server after the user has purchased an item through the site with a credit card.

A user might also be concerned, say, with an insurance Web site that requires input of sensitive data regarding the user's health—such as if the user has had a particular disease. The user may be concerned that his information not be passed on or made available to any other entity. Still another concern may be that the user wants to know whether or not the entity is going to spam the user's e-mail address.

The transformation module 124 is configured to perform an XSL (extensible Stylesheet Language) transformation on the privacy policy file 110, which is typically stored as an XML (extensible Markup Language) file. In fact, P3P requires the personal policy file to be an XML file. The XSL transformation transforms one XML file into another XML file. Although the present description refers exclusively to XML files, it is noted that in some circumstances, the privacy file may not be required to be an XML file.

The transformation module 124 is also configured to rearrange the data included in the privacy policy file 110 according to the concerns 120 set up by the user. In other words, the transformation module 124 is configured to place privacy policy statements that match user concerns at the beginning of a display shown on a user interface and to place the remainder of the privacy policy at the end of the display.

The UI module 122 is configured to present a user interface on the display 114 according to the manner in which the transformation module 124 orders the elements to be displayed.

Further functions attributed to the elements shown in FIG. 1 will be described in greater detail below, with respect to the following figures.

Methodological Implementation: Privacy Policy Evaluation

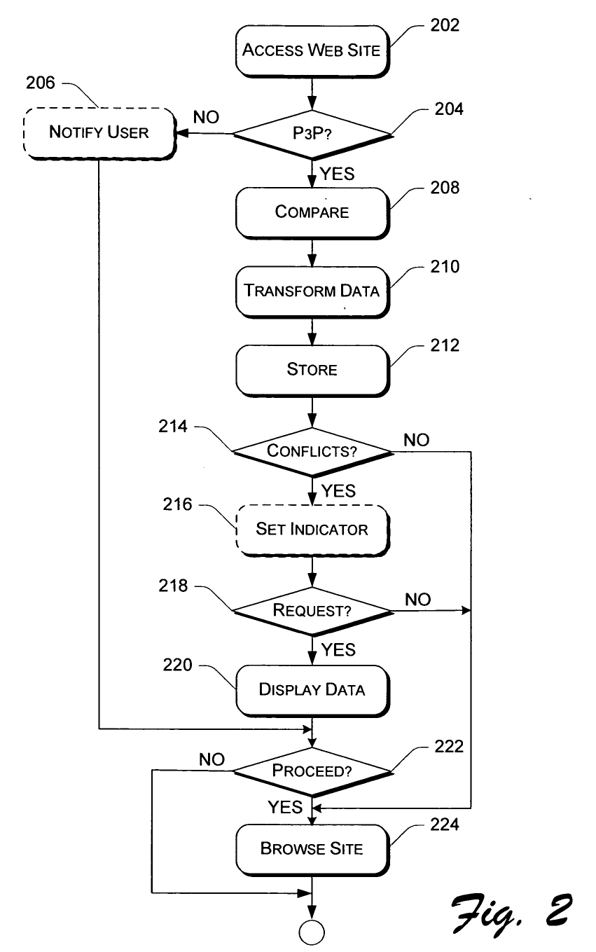

FIG. 2 is a flow diagram 200 that depicts a methodological implementation of the techniques described herein. In the discussion of FIG. 2, continuing reference will be made to the elements and reference numerals shown in FIG. 1.

At block 202, a user access a Web site, such as the Web site 102 shown in FIG. 1. The Web site may or may not include a privacy policy statement. If no privacy statement is present (“No” branch, block 204), then the user is notified at block 206 that the user cannot find out what the Web site's policies are in regard to privacy of user data.

The user is then queried (block 222) as to whether the user wishes to continue to browse the site. If the user wants to browse the site anyway (“Yes” branch, block 222), then the user continues browsing at block 224. If the user does not want to browse the site (“No” branch, block 222), then the user leaves the Web site.

It is noted that implementation of this notification is optional and is not required to implement other features of the described invention. Furthermore, the notification step 206 may be active, wherein a visible indicator is made available on the user's display; or it may be passive, wherein the user must first inquire as to a privacy policy before receiving the notification.

At block 208, the trust engine 116 compares the concerns 120 with the statements 112 included in the privacy policy file 110. The comparison is a standard Boolean match procedure which attempts to match keywords or tags included in the concerns 120 file with metatags included in the policy statements 112. P3P includes metatags that are known in the art and are published on an Internet site managed by the W3C. In addition, the trust engine 116 may also be configured to search for keywords in the privacy policy statements 112 instead of, or in addition to, the metatags.

At block 210, the transformation module 124 performs an XSLT (XSL transformation) on the statements 112 included in the privacy policy file 110. While, in some cases (such as the case where no matches between the statements 112 and the concerns 120 are found), the XSLT may simply transform the XML file containing the statements 112 to an XML file used to display an interface to the user, the XSLT is not always a mere transformation of an XML file to another XML file. The transformation module 124 is also configured to reorder or otherwise emphasize (with, e.g., highlights) the statements 112 for presentation by the UI module 122.

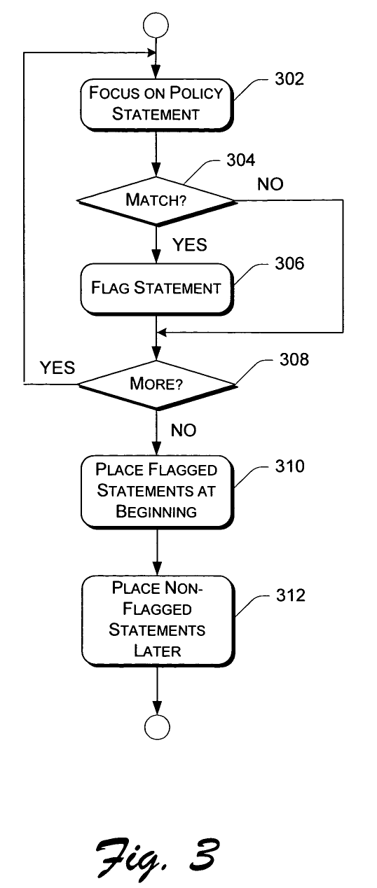

For instance, if one or more matches are found between the statements 112 and the concerns 120, the matched statements are placed at the beginning of a file to be displayed to the user. Any unmatched statements are then placed after the matched statements. This is described in greater detail, below, with respect to FIG. 3.

After the policy file data has been transformed at block 210, the resultant XML file is stored at block 212. In one or more implementations, the storing step is not required, as the transformed data may be immediately displayed to the user. However, in the exemplary implementation, the transformed file is stored on the client 104 so that it can be accessed for display at any time. For instance, in the described example, the comparison and transformation steps are performed for each Web site accessed by the user. The stored file may only be accessed and displayed upon request by the user.

In at least one other implementation, the comparison and transformation steps only occur when the user indicates a desire to view the privacy policy data. In this instance, the transformed data does not need to be stored but is immediately displayed.

If the comparison turns up any matches (“Yes” branch, block 214), then an indicator is set at block 216. This indicator may be a small icon placed on a toolbar of the user's display, or it could be a popup box configured to really get the user's attention. If no matches are found—indicating that the Web site privacy policies do not conflict with the user's concerns—(“No” branch, block 214), then the user continues to browse the site at block 224.

At block 218, the user may then opt to see the results by responding to the notification set in block 216 by, for example, clicking on a notification icon or responding to a popup box. If the user wants to see the results of the comparison (“Yes” branch, block 218), then the results are displayed by the UI module 122 at block 220. If the user does not want to see the results (“No” branch, block 218), then the user continues to browse the site at block 224.

As previously noted, when the policy statements are displayed to the user, the statements found to conflict with the user's concerns 120 are listed initially. The rest of the policy then follows those with which the user has expressed a primary interest. This user interface that handles this display may be configured in one of many ways available in the art to display data.

In one implementation, the user may be presented with an expandable-collapsible tree similar to those used extensively in products developed by Microsoft Corp.® in, for example, its Windows® family of operating systems or in Internet Explorer®. Each statement conflicting with one or more concerns may be identified by its own branch in the tree, with the remainder of statement identified by a single branch. Using this technique, a user may only be required to click on a conflicting statement identifier to see what the user really wants to see. The user can then be spared viewing the remainder of the statement (if the user 11 wishes) or can simply click on a particular branch to see other statements.

In another implementation, the entire privacy policy may be presented in the display. In this case, the conflicting statements are shown first, followed by the remainder of the statements. Here, a user may only need to read the first paragraph or so of data to find out what the user really wants to know about the privacy policy. Also, the user is always free to scroll down and view the remainder of the policy.

In yet another implementation, key words or phrases designated by the user as being of particular interest may be highlighted in a document that is presented to the user. In such a display, the user may then easily find sections of a privacy policy that are of interest to the user.

Any form of display that emphasizes privacy policy statements that conflict with user concerns over privacy policy statements that do not conflict with user concerns may be used in accordance with the claimed invention.

After the user views the policy conflicts at block 220, the user may wish to exit the Web site (“No” branch, block 222) or continue to browse the Web site at block 224 (“Yes” branch, block 222).

Methodological Implementation: Evaluation Details

FIG. 3 is a flow diagram 300 that depicts more details in the evaluation process shown and described in block 208 of FIG. 2. In the following discussion, continuing reference to elements and reference numerals used in previous figures will be used.

At block 302, the trust engine 116 focuses on a single policy statement 112 and attempts to determine if any item in that policy statement 112 matches any of the concerns 120 expressed by the user (block 304). If a match is found (“Yes” branch, block 304), then that particular statement is identified as being a conflicting statement at block 306. This identification may take the form of flagging the statement or relegating the statement to a “conflict bucket” which is utilized in further processing.

Additionally, when the trust engine 116 identifies a match, the trust engine 116 may be configured to add metadata to an internal representation of the matching statement. The additional metadata may trigger additional details within the statement to be emphasized during the transformation.

If there is no match, i.e. nothing in the policy statement 112 conflicts with a user concern 120 (“No” branch, block 304) then the next policy statement is focused on (block 302) if there are more policy statements 112 available (“Yes” branch, block 308).

When there are no more policy statements 112 to compare with user concerns 120 (“No” branch, block 308), the flagged statements (or statement contained in the conflict bucket) are placed at the beginning of a user display (block 310). Other, non-conflicting statements are placed after the conflicting statements at block 312.

As a result of the processes described in FIG. 2 and FIG. 3, the user is presented with a set of user-focused privacy concerns instead of a company-based set of privacy concerns. As a result, furtive attempts to hide unpopular usage of personal data are defeated and the user can quickly determine if the user wants to access the Web site.

Exemplary Computer Environment

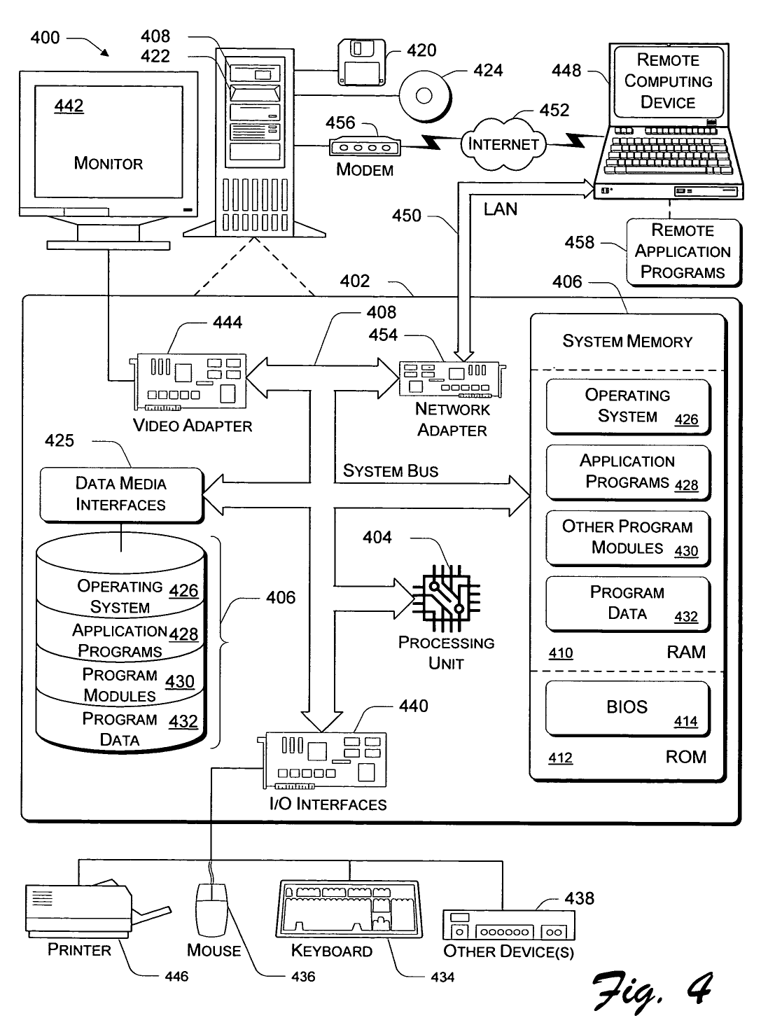

The various components and functionality described herein are implemented with a computing system. FIG. 4 shows components of typical example of such a computing system, i.e. a computer, referred by to reference numeral 400. The components shown in FIG. 4 are only examples, and are not intended to suggest any limitation as to the scope of the functionality of the invention; the invention is not necessarily dependent on the features shown in FIG. 4.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 4, the components of computer 400 may include, but are not limited to, a processing unit 402, a system memory 404, and a system bus 406 that couples various system components including the system memory to the processing unit 402. The system bus 406 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 400 typically includes a variety of computer-readable media. Computer-readable media can be any available media that can be accessed by computer 400 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 404 includes computer storage media in the form of volatile and/or nonvolatile memory such as read only memory (ROM) 408 and random access memory (RAM) 410. A basic input/output system 412 (BIOS), containing the basic routines that help to transfer information between elements within computer 400, such as during start-up, is typically stored in ROM 408. RAM 410 typically contains data and/or program modules that are immediately accessible to and/or presently being operated on by processing unit 402. By way of example, and not limitation, FIG. 4 illustrates operating system 414, application programs 416, other program modules 418, and program data 420.

The computer 400 may also include other removable/non-removable, volatile/nonvolatile computer storage media. By way of example only, FIG. 4 illustrates a hard disk drive 422 that reads from or writes to non-removable, nonvolatile magnetic media, a magnetic disk drive 424 that reads from or writes to a removable, nonvolatile magnetic disk 426, and an optical disk drive 428 that reads from or writes to a removable, nonvolatile optical disk 430 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 422 is typically connected to the system bus 406 through a non-removable memory interface such as data media interface 432, and magnetic disk drive 424 and optical disk drive 428 are typically connected to the system bus 406 by a removable memory interface such as interface 434.

The drives and their associated computer storage media discussed above and illustrated in FIG. 4 provide storage of computer-readable instructions, data structures, program modules, and other data for computer 400. In FIG. 4, for example, hard disk drive 422 is illustrated as storing operating system 415, application programs 417, other program modules 419, and program data 421. Note that these components can either be the same as or different from operating system 414, application programs 416, other program modules 418, and program data 420. Operating system 415, application programs 417, other program modules 419, and program data 421 are given different numbers here to illustrate that, at a minimum, they are different copies. A user may enter commands and information into the computer 400 through input devices such as a keyboard 436 and pointing device 438, commonly referred to as a mouse, trackball, or touch pad. Other input devices (not shown) may include a microphone, joystick, game pad, satellite dish, scanner, or the like. These and other input devices are often connected to the processing unit 402 through an input/output (I/O) interface 440 that is coupled to the system bus, but may be connected by other interface and bus structures, such as a parallel port, game port, or a universal serial bus (USB). A monitor 442 or other type of display device is also connected to the system bus 406 via an interface, such as a video adapter 444. In addition to the monitor 442, computers may also include other peripheral output devices 446 (e.g., speakers) and one or more printers 448, which may be connected through the I/O interface 440.

The computer may operate in a networked environment using logical connections to one or more remote computers, such as a remote computing device 450. The remote computing device 450 may be a personal computer, a server, a router, a network PC, a peer device or other common network node, and typically includes many or all of the elements described above relative to computer 400. The logical connections depicted in FIG. 4 include a local area network (LAN) 452 and a wide area network (WAN) 454. Although the WAN 454 shown in FIG. 4 is the Internet, the WAN 454 may also include other networks. Such networking environments are commonplace in offices, enterprise-wide computer networks, intranets, and the like.

When used in a LAN networking environment, the computer 400 is connected to the LAN 452 through a network interface or adapter 456. When used in a WAN networking environment, the computer 400 typically includes a modem 458 or other means for establishing communications over the Internet 454. The modem 458, which may be internal or external, may be connected to the system bus 406 via the I/O interface 440, or other appropriate mechanism. In a networked environment, program modules depicted relative to the computer 400, or portions thereof, may be stored in the remote computing device 450. By way of example, and not limitation, FIG. 4 illustrates remote application programs 460 as residing on remote computing device 450. It will be appreciated that the network connections shown are exemplary and other means of establishing a communications link between the computers may be used.

### Conclusion

The systems and methods as described thus provide a way to evaluate a Web site policy for a particular user and present any conflicts found between the policy and a set of predefined user concerns in a manner that makes it quick and convenient for a user to see potential problems that the user might have with how the Web site handles the user's personal data.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A method, comprising:
comparing user concerns with a Web site privacy policy to determine if any portion of the Web site privacy policy conflicts with one or more of the user concerns;
transforming the Web site privacy policy to emphasize portions of the Web site privacy policy that conflict with the user concerns; and
displaying the transformed Web site privacy policy so that the emphasized portions of the Web site privacy policy are demarcated from other portions of the Web site privacy policy.

2. The method as recited in claim 1, further comprising collecting user concerns from a user.

3. The method as recited in claim 2, further comprising collecting the user concerns from a user via a concerns settings user interface.

4. The method as recited in claim 1, wherein:
the Web site privacy policy includes one or more policy statements;
the comparing further comprises comparing each privacy policy statement with each user concern; and
a conflict is identified when there is a conflict between a privacy policy statement and a user concern.

5. The method as recited in claim 1, wherein the privacy policy further comprises a policy file that conforms to P3P (Platform for Privacy Preferences Project) standards.

6. The method as recited in claim 1, wherein the privacy policy is contained in an XML (eXtensible Markup Language) file.

7. The method as recited in claim 1, wherein the transforming step further comprises an XSL (extensible Stylesheet Language) transformation.

8. The method as recited in claim 1, further comprising notifying the user that a conflict exists between the user concerns and the Web site privacy policy file.

9. The method as recited in claim 1, wherein the displaying is only performed upon the user indicating that the user wants the transformed Web site privacy policy to be displayed.

10. The method as recited in claim 1, wherein the comparing, transforming and displaying steps are only performed when the user explicitly initiates a policy analysis.

11. A system, comprising:
a user concerns menu that is configured to allow a user to enter user concerns that are privacy concern preferences that apply to browsing Web sites;
a Web browser configured to allow the user to access one or more network Web sites;
a trust engine configured to compare the user concerns with a privacy policy file included in a Web site and to identify conflicts between the user concerns and the privacy policy file;
a transformation module configured to transform the privacy policy file into a user-centric policy display that emphasizes one or more portions of the privacy policy file that conflict with the user concerns; and
a user interface module configured to display a user interface that includes at least the portions of the privacy policy file that conflict with the user concerns.

12. The system as recited in claim 11, wherein the trust engine is further configured to compare each user concern with each of multiple statements making up the privacy policy file and to identify a match when a statement is found that contradicts a user concern.

13. The system as recited in claim 11, wherein the Web browser is further configured to provide a conflict notification when there is a conflict between a user concern and the privacy policy file.

14. The system as recited in claim 11, wherein the Web browser is further configured to provide a privacy actuator that, when activated, initiates the comparing, transformation and display.

15. The system as recited in claim 11, wherein the user interface module is further configured to display a user interface that displays the portions of the privacy policy file that conflict with the user concerns more prominently than the portions of the privacy policy file that do not conflict with the user concerns.

16. One or more computer-readable media including computer-executable instructions that, when executed on a computer, perform the following steps:
comparing a set of user concerns with a set of Web site privacy policy statements to determine if a privacy policy statement conflicts with a user concern;
if a conflict is identified between a user concern and a privacy policy statement, transforming the privacy policy statements for presentation to a user so that the privacy policy statement is emphasized over other, non-conflicting privacy policy statements; and
displaying a user interface that presents the privacy policy statements in the transformed state.

17. The one or more computer-readable media as recited in claim 16, further comprising collecting the set of user concerns from a user.

18. The one or more computer-readable media as recited in claim 16, further comprising receiving a prompt from a user before executing the comparing and the displaying.

19. The one or more computer-readable media as recited in claim 16, further comprising providing a conflict notification to a user to inform the user that a conflict has been found to exist between the privacy policy statements and the user concerns.

20. The one or more computer-readable media as recited in claim 16, further comprising providing a conflict notification to a user to inform the user that a conflict has been found to exist between the privacy policy statements and the user concerns, and only performing the displaying upon detection of a user response to the conflict notification.
